(19) United States
(12) Patent Application Publication
(10) Pub. No.: US 2016/0261590 A1
(43) Pub. Date: Sep. 8, 2016

(54) METHOD AND SYSTEM OF SHELVING DIGITAL CONTENT ITEMS FOR MULTI-USER SHARED E-BOOK ACCESSING

(71) Applicant: Kobo Incorporated, Toronto (CA)

(72) Inventors: Heather PIERCE, Toronto (CA); Courtney TODERASH, Toronto (CA)

(73) Assignee: Kobo Incorporated, Toronto (CA)

(21) Appl. No.: 14/637,184

(22) Filed: Mar. 3, 2015

(51) Int. Cl. H04L 29/06; G06F 17/21; G06F 17/30; G06F 3/0483

(52) U.S. Cl. CPC H04L 63/0861; G06F 3/0483; G06F 17/212; G06F 17/30256

(57) ABSTRACT

A method and system of system and method for operating a computing device for multi-user accessing of a shared e-book for reading within an e-library collection. The method is executed in a processor of a computing device, the computing device further including a display screen, a memory storing instructions and a database of fingerprint records associated with respective ones of a plurality of enrollees, and comprises receiving, at current page of the e-book at the display screen, a digital bookmarking command terminating display of the e-book content at the current page, receiving, at a fingerprint authentication interface, a superimposed fingerprint, recognizing a fingerprint record match between the superimposed fingerprint and one of the plurality of enrollees and correlating the superimposed fingerprint with the digitally bookmarked current page based on the fingerprint record match.

### TECHNICAL FIELD

Examples described herein relate to a system and method for operating a computing device for multi-user accessing of a shared e-book.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™ Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Soule electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system including a computing device configured for multi-user accessing of a shared e-hook for reading within an e-library collection, according to an embodiment.

FIG. 2 illustrates a schematic architecture of a computing device for multi-user accessing of a shared e-book for reading within an e-library collection, according to an embodiment.

FIG. 3 illustrates an embodiment in an example view of a computing device for multi-user accessing of a shared e-book for reading within an e-library collection, according to an embodiment.

FIG. 4 illustrates a method for operating a computing device for multi-user accessing of a shared e-book for reading within an e-library collection, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via. discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with e-Ink displays).

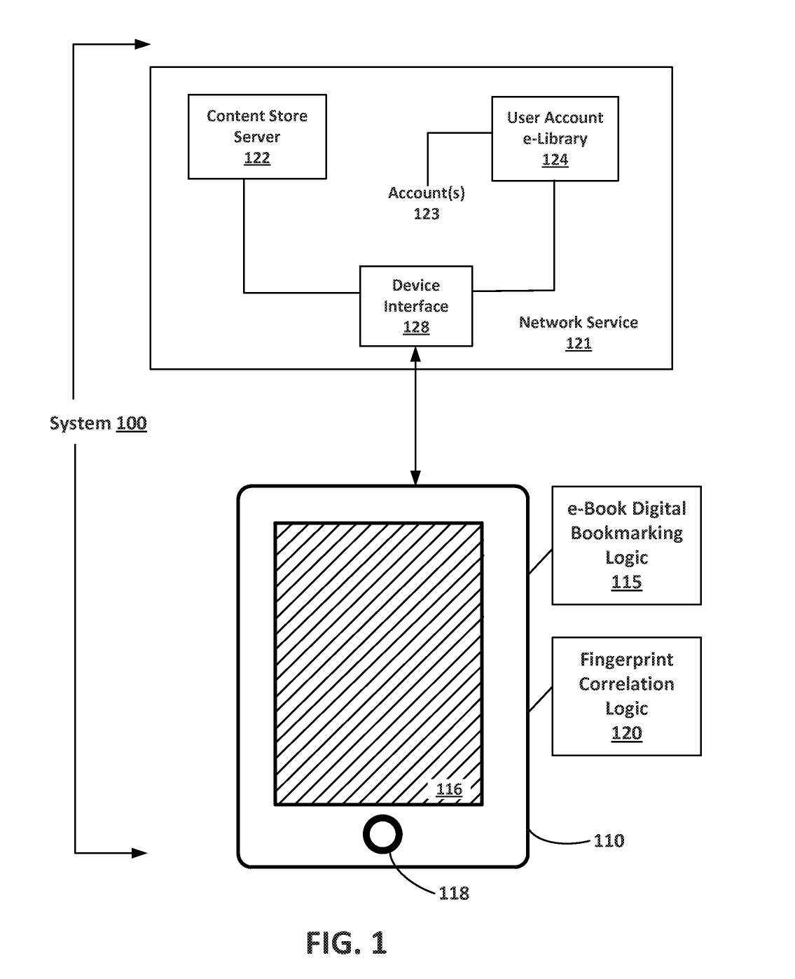

FIG. 1 illustrates a system 100 including a computing device 110 configured for multi-user accessing of a shared e-book for reading within an e-library collection 124, within which digital content items such as e-books may be assigned thereto and stored. In the example of FIG. 1, computing device 110 comprises an electronic personal display device, shown by way of example as e-reading device 110. The terms e-reading device, computing device and electronic personal display device are used interchangeably herein.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to a network service via a device interface 128 and enables e-books provided through the service to be downloaded and stored, for consumption by way of e-reading. In another implementation, the e-reading device 110 can run a media playback or streaming application that receives files or streaming data from the network service. By way of example, the e-reading device 110 can be equipped with hardware and software to optimize certain application activities, such as reading electronic content (e.g., e-books). For example, the e-reading device 110 can have a tablet-like form factor, although variations are possible. In some cases, display screen 116 of e-reading device 110 may be a liquid crystal display, an e-ink display, bi-stable display, or the like.

In additional detail, such a network service 121 can include a content store server 122, a user account electronic library (e-library) 124 storing e-books or digital content items, and account 123 which may be a user specific account stored in user account e-library 124. In sonic embodiments, the content store server 122 and user account e-library 124 may be implemented via server computing devices, as well as a server cloud computing system. The content store server 122 may be an on-line store from which digital content items, such as e-books, may be purchased. for download onto a resident memory of e-reading device 110 and/or the user account e-library 124, whereby the e-reading device 110 may be associated with the account. The user account can also be associated with ownership of and/or accessibility to, one or more e-books and digital content items stored in content store server.

Yet further, the content store server and user account e-library can retain metadata associated with e-books or other digital content items that have been purchased or made available for consumption via a user's e-library. Thus, information relating to each of the e-books within a user account e-library can include a metadata set in addition to substantive digital text and image content portions. The metadata set can include, for example, information such as the graphic representation of the e-book, such as including artwork- or image-based representation of a counterpart physical paper book cover, as well as summary information, author information, title, short synopsis or book review, publication date and language of the e-book, and book or volume series information.

Additionally, information typically rendered within precursor pages of paper books, such as an epigraph, a biographical page of the author, a table of contents, a book review, a book dedication, a foreword, author acknowledgements, an introduction, and a copyright notice may correspondingly be provided by, and accessible from, the metadata record unique to an e-book as electronically published. As used herein, the term precursor pages refers to the clustered pages of an e-book interposed between a displayed cover of the e-book and the actual substantive reading content within the e-book, providing information such as any or all of an epigraph, a biographical page of the author, a table of contents, a book review, a book dedication, a foreword, author acknowledgements, an introduction, and a copyright notice, and the like. The average e-book can typically feature a cluster of pages ranging from 3-15 precursor pages.

Further with reference to an example depiction of FIG. 1, the display screen 116 may be touch-sensitive, to process touch inputs including gestures, e.g., a swipe gesture comprising a sustained touch while moving along a particular direction upon the touchscreen surface). For example, display screen 116 may be integrated with one or more touch sensors to provide a touch-sensing region on their respective display surfaces. For some embodiments, the one or more touch sensors may include capacitive sensors that can sense or detect a human body's capacitance as input. In the example of FIG. 1, the touch-sensing region coincides with a substantial surface area, if not all, of display screen 116.

According to some embodiments, the e-reading device 110 includes display sensor logic to detect and interpret user input or user input commands made through interaction with the touch sensors of display screen 116. By way of example, display sensor logic can detect a user making contact with the touch-sensing region of the display screen 116, otherwise referred to herein as a touch event. More specifically, display sensor logic can detect a touch event also referred to herein as a tap, an initial tap held in contact at display screen 116 for longer than some pre-defined threshold duration of time (otherwise known as a “long press” or a “tong touch”), multiple taps performed either sequentially or generally simultaneously, swiping gesture actions made through user interaction with the touch sensing region of the display screen 116 or any combination of these gesture actions. Although referred to herein as a “touch” or a tap, it should be appreciated that in some design implementations, sufficient proximity to the screen surface, just short of actual physical contact, may register a “contact” or a “touch event”. Furthermore, display sensor lo noun interpret such interactions in a variety of ways. For example, each such interaction may be interpreted as a particular type of user input associated with a respective input command, execution of which may trigger a change in state at touchscreen display 116.

The touch screen display sensor capability may be used to transition through paginated content of an e-book. The e-reading device 110 can display pages from e-books, and enable the user to transition from one page state to another, including advancing forward or backward within the pages of e-book content. In particular, an e-book can comprise content that is rendered according to a sequence of digitally constructed pages, and the e-book can display page states in the form of single pages, multiple pages or portions thereof. In alternate embodiments, the e-book may be an e-magazine or an e-comic book, wherein each of the digitally constructed pages includes several distinctive panels or frames of text and/or images, and reading progression within a page may include navigating in sequential steps from one such panel or frame to another within a same page. Accordingly, a given page state can coincide with, for example, a single page, or two or more pages displayed at once, and in some implementations, the page transitioning feature may include single page transitions, chapter transitions, or cluster transitions (multiple pages at one time) within the sequence of digitally constructed pages comprising the e-book.

E-book digital bookmarking logic module 115 provides, in an embodiment, for detecting a user applying a digital bookmark at a particular page location, or page portion location, within the digital pages of e-book content, such as by way of terminating a reading session prior to full completion to end of the e-book. Upon a user selecting the e-book for resumption of reading, e-book digital bookmarking logic module 115 may provide an option for navigating directly to a bookmarked page location within the e-book for seamless resumption of reading from that last read page or page portion.

The e-reading device 110 may include fingerprint correlation logic 120, which in one embodiment may store a database of fingerprint records for a plurality of users who have enrolled or registered for such service in regard at least to operation of computing device 110, providing a basis for correlation or association of users via their respective fingerprint records with actions they might undertake during a given e-reading session of an e-book at display screen 116 of computing device 110.

E-book bookmarking logic module 115 and fingerprint correlation logic module 120 can be implemented as software modules comprising instructions stored in a memory of a computing device such as the content store server and/or display device 110. One or more embodiments of e-book digital bookmarking logic module 115 and/or fingerprint correlation logic module 120 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of e-book digital bookmarking logic module 115 and fingerprint correlation logic module 120 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

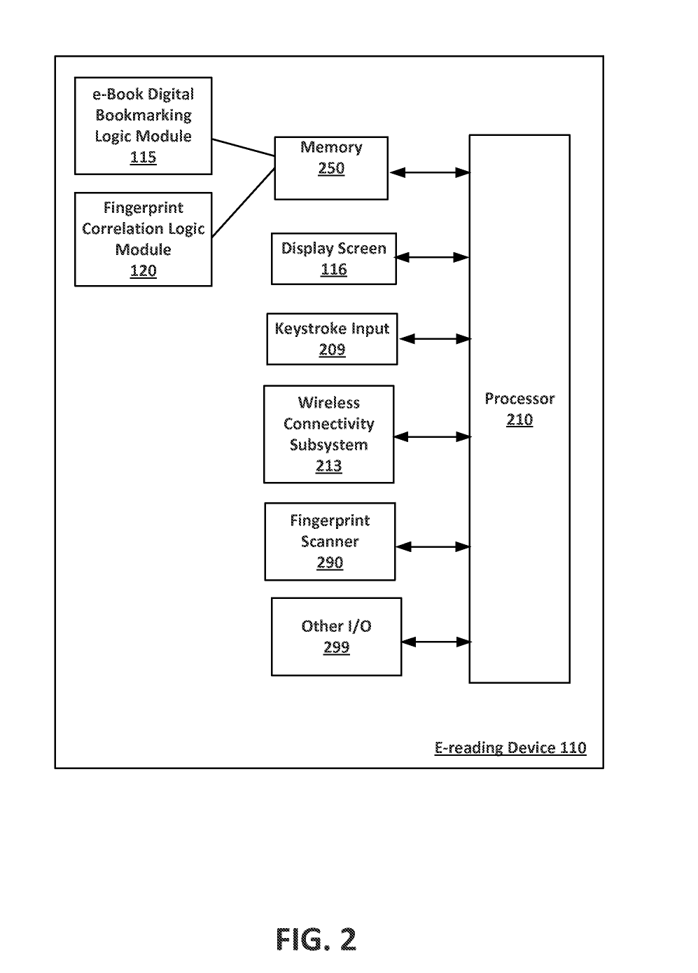

With reference now to FIG. 2, illustrated is a schematic architecture of a mobile computing device 110, such as a tablet or e-reader, for multi-user accessing of a shared e-book for reading within an e-library collection, according to an embodiment.

E-reading device 110 further includes processor 210, a memory 250 storing instructions and logic pertaining at least to display sensor logic, e-book digital bookmarking logic module 115 and fingerprint correlation logic module 120.

Processor 210 can implement functionality using the logic and instructions stored in memory 250. Additionally, in some implementations, processor 210 communicates with the network service. More specifically, the e-reading device 110 can access the network service to receive various kinds of resources, e.g., digital content items including e-books, digital videos, as well as configuration files and account information, as well as to provide information (e.g., user account information, service requests etc.). For example, e-reading device 110 can receive application resources, including digital content items such as e-books or media files that the user elects to purchase or otherwise download via the network service. The application resources, including e-books having content organized as a series of digitally constructed pages, that are downloaded onto the e-reading device 110 can be stored in memory 250.

In some implementations, display screen 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components may be integrated with display 116. In other embodiments, the touch sensor components may be provided (e.g., as a layer) above or below display 116 such that individual touch sensor components track different regions of display 116. Display screen 116 can correspond to an electronic paper type display, such as an e-ink or bi-stable display that mimic conventional paper in the manner in which content is displayed. Examples of such electronic paper display technologies include electrophoretic displays, electro-wetting displays, and electro-fluidic displays.

Processor 210 can receive input from various sources, including touch sensor components at display 116, keystroke input 209 such as from a virtual or rendered keyboard, fingerprint scanner 290, one or more audio output speakers and other input mechanisms 299 (e.g., buttons, mouse, earphone plug-in jack, wirelessly coupled speakers, etc.). With reference to examples described herein, processor 210 can respond to input detected at the touch sensor components. In some embodiments, processor 210 responds to inputs from the touch sensor components in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic that monitors for user interactions detected through the touch sensor components, and further processes the user interactions as a particular input or type of input. In an alternative embodiment, display sensor logic module may be integrated with the touch sensor components. For example, the touch sensor components can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

Memory 250 also stores digital content items including e-books having respectively associated metadata records, cache-book having its unique metadata record in addition to the substantive content of the e-book, i.e., the digitally constructed paginated content for e-reading via the display screen of the e-reading device.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which display device 110 is intended to operate, such as in accordance with Wi-Fi, Bluetooth, Near Field Communication (NFC) communication protocols, and the like. In an embodiment, fingerprint scanner 290 may be coupled with, or incorporated within, computing device 110 to provide a fingerprint authentication interface and functionality.

Fingerprint correlation logic module 120 operates in conjunction with e-book digital bookmarking logic module 115 to provide an option for uniquely correlating a given user with a digital bookmark enacted by that user during e-reading of a specific book, such as a title selectable from e-library 124, at display 116 of computing device 110. Multiple users may enroll their respective fingerprint signature, such as via fingerprint scanner 290, at computing device 110. Fingerprint logic module 120, in one embodiment, may store or access a database of fingerprint records for a plurality of users who have enrolled or registered for such service in regard at least to operation of computing device 110, providing a basis for subsequent correlation of respective user actions, such as placement of a digital bookmark, consistent with recognizing a respective fingerprint record.

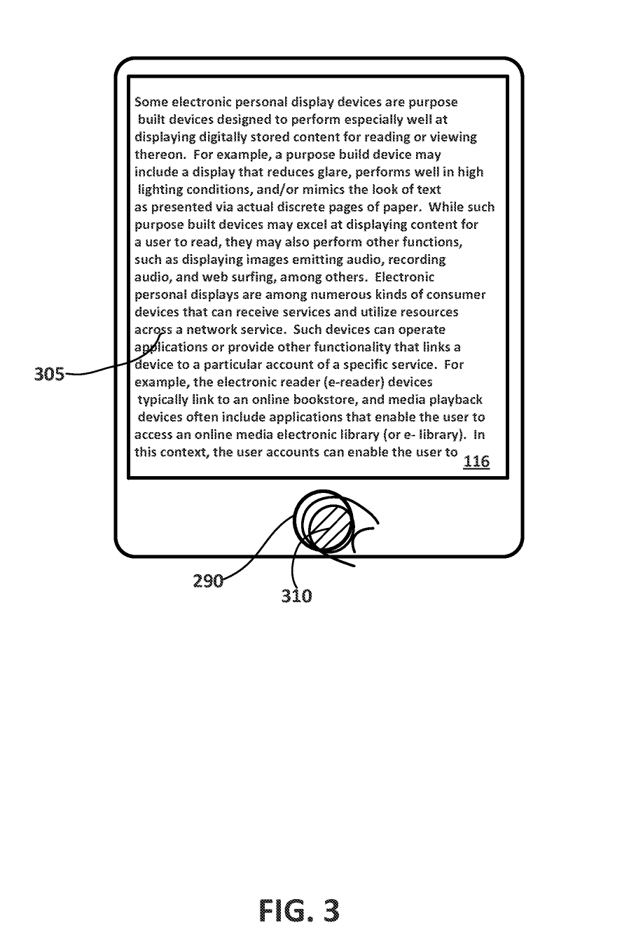

FIG. 3 illustrates an embodiment in an example view of a computing device for multi-user accessing of a shared e-book for reading within an e-library collection.

In this case depicted, fingerprint scanner 290, such as a capacitive fingerprint scanner, is physically coincident in disposition with a HOME button 118 located at a front surface of computing device 110.

While e-reading at a current page 305 of e-book content at display screen 116 of computing device 110, the user may decide to terminate the reading session by placing a digital bookmark, marking that current page 305 location, or page portion location for subsequent resumption of reading therefrom, thereby invoking functionality of e-book digital bookmarking logic 115.

In a context where that particular e-book is concurrently being read by multiple users accessing and sharing user account e-library 124, a given user may decide to have their bookmark associated with their unique reading actions, for personal convenience in seamlessly resuming reading at a later time. Thus a user fingerprint 310 providing that user's fingerprint pattern may be applied by way of superimposition at fingerprint scanner 290. Next, functionality of fingerprint correlation logic 120 may be invoked to detect or recognize a fingerprint record match, thus uniquely identifying that user among the enrollees' fingerprints, whereupon the digital bookmark is uniquely correlated with that identified user in accordance with the match.

Next, when that identified user indicates an intention to resume reading the e-book, such as by selection of the e-book from a menu of e-books accessible at display screen 116 at computing device 120, upon application of the user's fingerprint 310 at fingerprint scanner 290, navigation to previously bookmarked current page 305 may be automatic, with presentation of current page 305 for reading at display screen 116. In alternate embodiments, it is contemplated that selection of a last read e-book may be automatic upon transitioning of computing device 110 to a power-ON or a higher power state, including when a user activates transition to a wake state from a sleep (or low power usage) state of processor 210 of computing device 110.

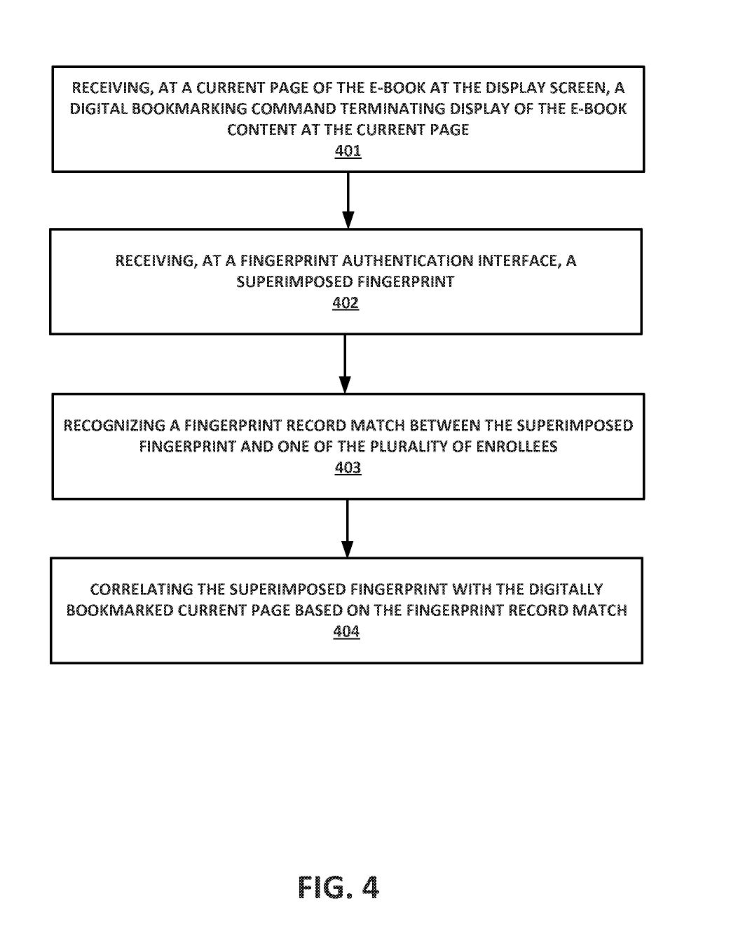

Next with reference to FIG. 4, illustrated is a method for operating a computing device for multi-user accessing of a shared e-book for reading within an e-library collection, according to an embodiment. In describing the example of FIG. 4, reference will be made to components such as described with regard to FIGS. 1-3 for purposes of illustrating components for performing a step or sub-step as described.

At 401, one embodiment receives, at a current page 305 of the e-book at the display screen 116, a digital bookmarking command terminating display of the e-book content at the current page 305 of computing device 110.

At 402, one embodiment receives, at a fingerprint scanner 290, a superimposed fingerprint 310 provided by a user's fingertip. In an embodiment, the fingerprint authentication interface incorporates a fingerprint scanner 290, such as a capacitive scanner, and is physically coincident in disposition with a HOME button 118 located on a front surface of computing device 110. In an embodiment of operation, when fingerprint authentication scanner 290/HOME button 118 is touched, a surrounding stainless steel ring located there within detects the superimposed fingerprint 310 and wakes a capacitive touch sensor. A laser-cut sapphire crystal surface of the button then directs the image of the superimposed fingerprint 310 to the sensor, which reads beneath the outer layers of the fingertip skin to record a detailed fingerprint. Fingerprint correlation logic module 120 then reads the ridges of the fingerprint and looks for a match with any one of a set of enrolled fingerprint records within a database at memory 250 at computing device 110.

At 403, one embodiment recognizes a fingerprint record match between the superimposed fingerprint 310 and one of the pluralities of enrollees at the computing device 110.

At 404, one embodiment correlates the superimposed fingerprint 310 with the digitally bookmarked current page 305 based on the fingerprint record match in a database at memory 250.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a display screen, a memory storing instructions and an e-book, the e-book including an ordered series of digital content pages, and a database of fingerprint records associated with respective ones of a plurality of enrollees, the method comprising:
receiving, at a current page of the e-hook at the display screen, a digital bookmarking command terminating display of an e-book content at the current page;
receiving, at a fingerprint authentication interface, a superimposed fingerprint;
recognizing a fingerprint record match between the superimposed fingerprint and one of the plurality of enrollees; and
correlating the superimposed fingerprint with the digitally bookmarked current page based on the fingerprint record match.

2. The method of claim 1 further comprising:
selecting the e-book at the computing device for resumption of reading thereon;
receiving the superimposed fingerprint at the fingerprint authentication interface; and
upon recognizing the superimposed fingerprint as matching the fingerprint of the one of the plurality of enrollees, navigating to the current page of the selected e-book for continued reading at the display screen.

3. The method of claim 2 wherein the e-book is selected for resumption of reading upon a transition to a higher-power state of the computing device from a low-power-usage sleep state.

4. The method of claim 2 wherein the e-hook is selected for resumption of reading upon a transition to a power-on state of the computing device from a device power-off state.

5. The method of claim 1 wherein the display screen is a touchscreen display.

6. The method of claim 5 wherein the touchscreen display is one of a light emitting diode (LED) display, a liquid crystal display (LCD), and a bi-stable e-ink display.

7. The method of claim 1 wherein the e-book is one of an e-magazine and an e-comic.

8. The method of claim 1 wherein the fingerprint authenticating interface is provided on a front surface of the computing device.

9. The method of claim 8 wherein the fingerprint authenticating interface is coincident with a home button provided on the front surface of the computing device.

10. The method of claim 9 wherein the fingerprint authenticating interface incorporates a capacitive scanner.

11. A computing device comprising:
a memory that stores a set of instructions, an e-book having content arranged in an ordered series of digitally constructed pages and a database of fingerprint records associated with respective ones of a plurality of enrollees;
a display screen; and
a processor that access the instructions in memory, the processor further configured to:
receive, at current page of the e-book at the display screen, a digital bookmarking command terminating display of an e-book content at the current page;
receive, at a fingerprint authentication interface, a superimposed fingerprint;
recognize a fingerprint record match between the superimposed fingerprint and one of the plurality of enrollees; and
correlate the superimposed fingerprint with the digitally bookmarked current page based on the fingerprint record match.

12. The computing device of claim 11 further wherein the processor is further configured to:
select the e-book at the display screen for resumption of reading thereon;
receive the superimposed fingerprint at the fingerprint authentication interface; and
upon recognizing the superimposed fingerprint as matching the fingerprint of the one of the plurality of enrollees, navigating to the current page of the selected e-book for continued reading at the display screen.

13. The computing device of claim 12 further wherein the e-book is selected for resumption of reading upon a transition to a higher-power state of the computing device from a low-power-usage sleep state.

14. The computing device of claim 12 wherein the e-book is selected for resumption of reading upon transition to a power-on state of the computing device from a device power-off state.

15. The computing device of claim 11 wherein the display screen is a touchscreen display.

16. The computing device of claim 15 wherein the touchscreen display is one of a light emitting diode (LED) display, a liquid crystal display (LCD), and a bi-stable e-ink display.

17. The computing device of claim 16 wherein the e-book is one of an e-magazine and an e-comic.

18. The computing device of claim 11 wherein the fingerprint authenticating interface is provided on a front surface of the computing device.

19. The computing device of claim 18 wherein the fingerprint authenticating interface is coincident with a home button provided on the front surface of the computing device.

20. The computing device of claim 19 wherein the fingerprint authenticating interface incorporates a capacitive scanner.
